(19) United States
(12) Patent Application Publication
(10) Pub. No.: US 2017/0171790 A1
(43) Pub. Date: Jun. 15, 2017

(54) CELL CHANGE IN A MULTI-CARRIER OPERATING CELLULAR RADIO NETWORK

(71) Applicants: Joachim WEHINGER, UNTERHACHING (DE); Jianjun SHEN, UNTERHACHING (DE); Anil kumar HARIHARAKRISHNAN, NEUBIBERG (DE)

(72) Inventors: Joachim WEHINGER, UNTERHACHING (DE); Jianjun SHEN, UNTERHACHING (DE); Anil kumar HARIHARAKRISHNAN, NEUBIBERG (DE)

(21) Appl. No.: 15/346,778

(22) Filed: Nov. 9, 2016

(30) Foreign Application Priority Data
Dec. 11, 2015 (DE) 10 2015 121 610.8

(51) Int. Cl. H04W 36/26; H04W 24/10; H04W 36/04

(52) U.S. Cl. CPC H04W 36/26; H04W 36/04; H04W 24/10

(57) ABSTRACT

An apparatus for determining cell-specific reporting signals of a multi-carrier cellular network includes a measurement unit configured to measure a plurality of reception qualities in a mobile device, wherein each reception quality indicates a reception quality of a specific carrier of a specific cell. Further, the apparatus includes a reporting signal generation unit configured to generate the reporting signal of a specific cell based on the plurality of reception qualities for a plurality of carriers of the specific cell.

This application claims the benefit of priority to German Patent Application No. 10 2015 121 610.8, filed Dec. 11, 2015, which is incorporated herein by reference in its entirety.

### FIELD OF THE INVENTION

The invention relates to cell change techniques in multi-carrier operating cellular radio networks, and more particularly to a device for determining cell-specific reporting signals configured to operate in a multi-carrier operating cellular radio network.

### BACKGROUND OF THE INVENTION

Cell change, also referred to as handover, is used in radio receiver apparatus when traversing through overlapping and/or adjacent radio cells of the cellular radio network. Cell change is based on mobility (handover) measurements in a mobile device, reportings to the radio network and radio network procedures. It is desirable to provide for a high receiver performance in the presence of one or more cells.

### BRIEF DESCRIPTION OF THE DRAWINGS

The accompanying drawings are included to provide a further understanding of aspects and are incorporated in and constitute a part of this specification. The drawings illustrate aspects and together with the description serve to explain principles of aspects. Other aspects and many of the intended advantages of aspects will be readily appreciated as they become better understood by reference to the following detailed description. Like reference numerals designate corresponding similar parts.

FIG. 1 is a schematic diagram of a cellular radio network including multiple base stations and configured for multi-carrier operation.

FIG. 2 is a graph illustrating measurements of reception qualities of various carriers from different base stations in a mobile device.

FIG. 3 is a schematic diagram illustrating reporting of cell parameters from a mobile device to a multi-carrier cellular radio network.

FIG. 4 is a schematic block diagram of an exemplary reporting signal determining apparatus in a mobile device.

FIG. 5 is a schematic block diagram of an exemplary reporting signal generation unit of the reporting signal determining apparatus of FIG. 4.

FIG. 6 is a schematic block diagram of an exemplary reporting signal synthesizing unit of the reporting signal generation unit of FIG. 5.

FIG. 7 is a diagram illustrating a method of generating the cell parameters of the report signal for cell allocation to the mobile device in the cellular radio network.

### DETAILED DESCRIPTION

In the following detailed description, reference is made to the accompanying drawings, which form a part thereof, and in which is shown by way of illustration specific aspects in which the invention may be practiced. It is understood that other aspects may be utilized and structural or logical changes may be made without departing from the scope of the present invention. The following detailed description, therefore, is not to be taken in a limiting sense, and the scope of the present invention is defined by the appended claims.

Further, to the extent that the terms “include”, “have”, “with” or other variances thereof are used in either the detailed description or the claims, such terms are intended to be inclusive in a manner similar to the term “comprise”. Also the term “exemplary” is merely meant as an example rather than the best optimum.

In the following description and claims, the terms “coupled” and “connected”, along with derivatives may be used. It should be understood that these terms may be used to indicate that two elements co-operate or interact with each other regardless whether they are in direct physical or electrical contact, or they are not in direct contact with each other, i.e. intermediate elements are interconnected between them. In some embodiments, however, the terms “coupled” and “connected” may have the specific meaning of a direct electrical contact without intermediate elements in between.

The devices and methods described herein may be based on functional units of a mobile device (i.e. mobile station) and/or a radio network controller (RNC) of a cellular radio network. It is understood that features disclosed in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

The methods and devices described herein may be implemented in wireless communication networks, in particular communication networks based on mobile communication standards such as HSPA (High Speed Packet Access), CDMA (Code Division Multiple Access) standards such as, e.g., UMTS (Universal Mobile Telecommunications System), TD-SCDMA (Time-Division Synchronous CDMA) or IS95 and its derivatives (e.g. IS95-EvDo), cdma2000 and its derivatives (e.g. cdma2000-EvDo), or OFDM (Orthogonal Frequency Division Multiplex) standards such as, e.g., LTE (Long Term Evolution) and its derivatives (e.g. LTE-Advance (LTE-A), also marketed as 4G LTE).

The methods and devices described herein may be implemented in Multi-Carrier (MC) wireless communication networks. In MC communication systems, multiple carriers are aggregated with the effect that peak data rates and capacity can be increased considerably. By way of example, in MC-HSPA multiple (e.g. 2, 3, 4 or 8) 5 MHz wide carriers are aggregated while in DC (Dual-Carrier)-HSPA, two such carriers are aggregated. In LTE-A, it has been proposed to aggregate a plurality of (up to) 20 MHz wide carriers (per LTE standard today, e.g. 5×20 MHz carrier aggregation is possible) and in cdma2000 EvDo an aggregation of several 1.25 MHz wide carriers was introduced.

The methods and devices described herein may further be implemented in a mobile device. The described mobile devices may include integrated circuits and/or passives and may be manufactured according to various technologies. For example, the circuits may be designed as logic integrated circuits, analog integrated circuits, mixed signal integrated circuits, optical circuits, memory circuits and/or integrated passives.

The following description relates to radio receiver apparatus operating in a cellular network configured to support hard handover. Typically, multi-cell operation as considered herein is targeting purely data-connections, and these may all be operated in hard handover. In hard handover, the radio connection in one cell is lost before a new radio connection in another cell is established. As such, a (data-)connection exists only to a single base station at a time. By way of example, some multi-carrier modulation systems such as, e.g., OFDM radio communications systems including systems as stipulated in the LTE (Long Term Evolution) standard and its derivatives may use hard handover. However, also radio communications system using soft handover (e.g. for circuit-switched voice-call connections to grant seamless connectivity when crossing various network cells) may be configured to use hard handover (e.g. for data-connections), if appropriate. By way of example, hard handover is also used in UMTS systems.

The methods and devices described herein may be configured to transmit and/or receive radio signals. Radio signals may be radio frequency signals radiated by a radio transmitting device (or radio transmitter or sender) with a radio frequency lying in a range of about 3 Hz to 300 GHz. The frequency range may correspond to frequencies of alternating current electrical signals used to produce and detect radio waves.

Mobile receiver apparatus as described herein may form a part of a mobile device of a wireless network. In the following the terms mobile station or mobile device and user equipment (UE) shall have the same meaning, which meaning shall comprise the definitions given in the various standards as mentioned above. In the following the term UE is used. By way of example, a UE may be represented by a cellular phone, a smart phone, a tablet PC, a laptop, etc.

In a wireless network for mobile UEs with numerous cells the network and the UE have a mechanism to decide to which cell the UE is to be connected. Usually, this should be the best cell. When the UE is moving, a decision has to be made when to handover the UE to the next cell. In a soft handover wireless network, where the UE is connected to several cells at the same time (in case of UMTS e.g. up to six cells), the UE has an “active set” of cells to which it is connected and a “monitored set” of cells which are monitored but to which it is not connected. Active set updating as initiated by the handover decision may comprise various procedures such as, e.g., adding a new cell to the active set, removing a cell from the active set, replacing a cell of the active set by a cell of the monitored set (e.g. if the active set is full) and changing the best cell of the active set.

In hard handover wireless networks like, e.g., LTE and its derivatives, the “active set” typically only comprises one cell, namely the serving cell. Again, the “monitored set” comprises cells which are monitored but to which the UE is not connected (e.g. no data-connection is established to these cells). During hard handover the serving cell is replaced by another cell of the monitored set, which then becomes the serving cell.

In cellular wireless networks the parameters of the cells must be determined to decide appropriate cell reallocation, e.g. active set updating or serving cell replacement. To this end, the UE is configured to report cell parameters to the network. Such reportings are generated for all cells (e.g. the neighboring NodeBs), e.g. the serving cell and the cells of the monitored set. The reported cell parameters are based on measurements performed in the UE. The network or, more specifically, the RNC connected to one or more base stations of the network then evaluates the cell parameters and performs cell reallocation to the UE. More specifically, as soon as one of the cell parameters of a neighboring cell indicates this cell “becomes stronger” than those of the current serving cell, then the RNC might trigger a serving cell change (handover), as reception quality degrades as soon as an interfering cell (e.g. interfering NodeB) becomes stronger than the serving cell (e.g. serving NodeB). These and other concepts are more specifically described byway of example in the following embodiments when read in conjunction with the appended figures.

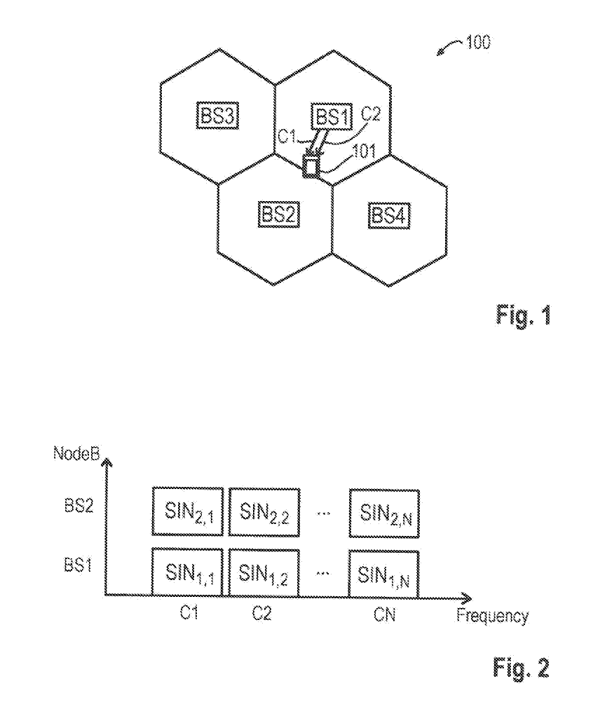

FIG. 1 illustrates an exemplary cellular radio network 100 including multiple base stations (NodeBs) BS1, BS2, BS3, BS4, . . . and a plurality of mobile devices, of which exemplary mobile device UE 101 is depicted. The cellular radio network 100 is composed of cells, wherein each cell is, e.g., served by a base station BS1, BS2, BS3, BS4, . . . .

Cells served by different base stations BS1, BS2, BS3, BS4, . . . typically use differently coded signals in order to reduce interference from neighboring cells. Coding, in this context, shall have a broad meaning including time division coding, frequency division coding, scrambling, spreading, etc. By way of example, considering, e.g., a WCDMA cellular radio network 100, signals from different base stations BS1, BS2, BS3, BS4, . . . may be encoded by different scrambling codes.

Target UE 101 is, e.g., located near to a cell boundary. Byway of example, the cell of base station BS1 is the serving cell and the cell of base station BS2 is an interfering cell. That is, UE 101 uses the scrambling code allocated to base station BS1 in order to detect the signals of the serving cell. The scrambling code allocated to base station BS2 is different from the scrambling code allocated to base station BS1.

The cellular radio network 100 is configured for multi-carrier operation. As explained above, this means that the UE 101 is capable to receive and monitor multiple frequency bands (i.e. downlink carriers) C1, C2, . . . simultaneously. This may imply that the UE 101 is equipped with multiple RF chains, wherein each RF chain is associated with one carrier C1 and C2, respectively. Byway of example, if a first carrier C1 has a center band frequency at f1 and a second carrier C2 has a center band frequency at f2, an RF chain operating at f1 and an RF chain operating at f2 may be implemented in the UE 101. If the two carriers C1, C2 are adjacent carriers, it may also be possible to use only one RF chain operating at a down-conversion frequency (f1+f2)/2 in the analog processing section of the UE and to separate the carriers C1, C2 by multiplication of the down-converted, filtered and digitalized signal with (f1−f2)/2 and (f2−f1)/2, respectively, in the digital processing section of the UE.

In conventional cellular radio networks, the cell parameters reported to the network (or RNC) are typically based on measurements performed on a common pilot channel. The cell parameters maybe determined by measuring the RSCP (received signal code power) and/or the Ec/Io (i.e. the chip energy Ec divided by the interference density Io) of the common pilot channel (CPICH). Other possibilities for determining the cell parameters are to measure the PL (pathloss) and/or the ISCP (interference on signal code power), wherein the ISCP may, e.g., in particular be used as an (additional) metric for TD-SCDMA. Note that the pathloss PL in dB may, e.g., be defined as:
PL[dB]=Tx power of the primary CPICH−RSCP of the CPICH.

Typically, the CPICH is transmitted with a constant power throughout all base stations. The cell parameters are measured for one or a plurality of cells (e.g. the cell(s) of the active set and the cells of the monitored set). In multi-carrier cellular networks, the cell parameters are typically determined and reported for the primary carrier (e.g. carrier C1) only, irrespective of the conditions on the other associated carriers C2, C3, . . . .

According to the disclosure herein, cell specific parameters reported to the network (or RNC) may be adjusted in the UE 101 to take into account a reception quality for the cell under consideration. Reception quality means a quality which reflects conditions at the receiver, e.g. one or more conditions selected from the group of conditions consisting of: the general receiver type, (e.g. Rake, equalizer, sphere decoder, etc.), the number of receive antennas, the interference suppression/cancelation capabilities (e.g. beamforming, deterministic cancellation) and the loading of interfering cell(s). Thus, the reception quality as considered herein is typically affected by signal processing in the UE including equalization and/or interference cancellation processing and/or demodulation. By way of example, the reception quality may be expressed by a post-equalization SINR (signal-to-interference plus noise ratio) and/or by a post-demodulation SINR. Another possibility is to use mutual-information (MI) to indicate the reception quality.

Further according to the disclosure herein, cell specific parameters (also referred to as cell reporting parameters in the following) reported to the network (or RNC) may be adjusted in the UE 101 to take into account the reception qualities for a plurality of carriers (i.e. not only the primary carrier) of the cell (s) under consideration. By way of example, the reception qualities for all carriers C1, C2, . . . of the cell(s) under consideration (e.g. the serving cell of BS1 and the neighboring cells of BS2, BS3, BS4, . . . ) are taken into account. That is, each reception quality may be indicative of a reception quality of a specific carrier i, with i=1, 2, . . . , N, of a specific cell x, with x=1, 2, . . . , M, wherein N is the number of carriers of a specific cell and M is the number of cells under consideration.

For instance, the reception quality of carrier i of cell x may be expressed by a post-equalization or post-demodulation SINR, namely SINR_{x,i}. In this case, the reporting signal relating to cell x may be generated based on the plurality of reception qualities for a plurality of carriers of the specific cell x, e.g. on the SINR_{x,i} with i=1, 2, . . . , N (i.e. all carriers) or with i=1, 2, . . . , N_{S} with Nₛ<N, i.e. a subset of all carriers. Analogously, if MI is used as reception quality indicator, the reporting signal relating to cell x may be generated based on the plurality of reception qualities for a plurality of carriers of the specific cell x, e.g. on the MI_{x,i} with i=1, 2, . . . , N (i.e. all carriers) or with i=1, 2, . . . , N_{S}. In the following, without loss of generality and for ease of explanation only, the SINR will be exemplarily used as reception quality indicator and all N carriers are considered.

FIG. 2 illustrates a measurement of a plurality of reception qualities which, in this example, are represented by SINR_{x,i}. The reception qualities SINR_{x,i} can principally be different between different NodeBs (e.g. different base stations BS1, BS2, BS3, BS4, . . . ) and across different carriers C1, C2, . . . , CN. FIG. 2 depicts an example of two NodeBs BS1, BS2 operating on N carriers C1, C2, . . . , CN. In practice, the individual SINR_{x,i} can be very different (as mentioned, the same applies to the individual MI_{x,i}).

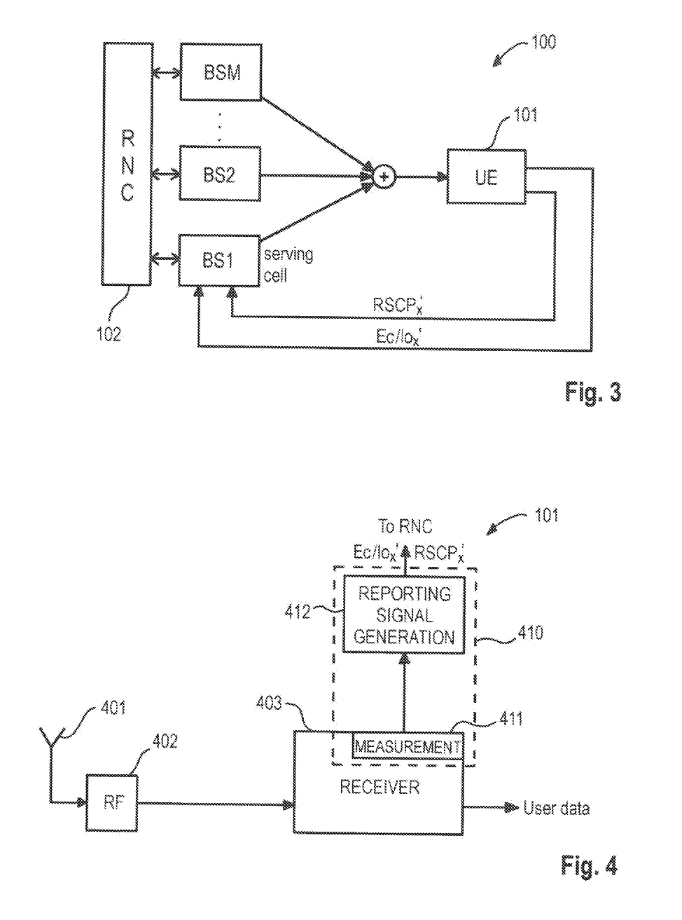

FIG. 3 illustrates the reporting of cell parameters from the mobile device UE 101 to the multi-carrier cellular radio network 100 or, more specifically, to the RNC 102. By way of example, the NodeB referenced by BS1 maybe the NodeB of the serving cell. Similar to the reporting in conventional networks, one-dimensional measurement reportings (i.e. reportings which are measured for the primary carrier only) may be generated in the UE 101 and transmitted to the RNC 102 via, e.g., the base station BS1 of the serving cell. In the example illustrated in FIG. 3, the (one-dimensional) measurement reportings are, e.g., RSCPₓ and/or Ec/Ioₓ. However, these (one-dimensional) measurement reportings RSCPₓ and/or Ec/Ioₓ may, according to the disclosure herein, be replaced by corresponding reportings RSCPₓ′ and/or Ec/Ioₓ′ based on the plurality of reception qualities (e.g. SINR_{x,i}) for a plurality of N (or N_{S}) carriers i of the specific cell x.

By way of example, RSCPₓ′ may depend on the RSCPₓ of the common pilot channel (e.g. the CPICH-RSCPₓ) adapted or modified by a function of SINR_{x,i}. By way of example, Ec/Ioₓ′ may depend on the Ec/Ioₓ of the common pilot channel (e.g. the CPICH-Ec/Ioₓ) adapted or modified by a function of SINR_{x,i}.

In the following description, without loss of generality, the cell reporting parameters will be exemplified by RSCP and/or Ec/Io quantities, while keeping in mind that cell reporting parameters may, e.g., also comprise PL and/or ISCP quantities. The RNC 102 may receive the (one dimensional) cell reporting parameters RSCPₓ′ and/or Ec/Ioₓ′ from the serving cell spanned by base station BS1. Based on these cell reporting parameters the RNC 102 decides on a cell reallocation, e.g. a change of the serving cell or an updating of the active set or monitoring set in the UE 101. The algorithm used by the RNC 102 to decide for cell reallocation may be identical to the algorithm conventionally used in the cellular radio network 100. That is, the RNC 102 does not need to have knowledge about the method of generating the cell reporting parameters (e.g. RSCPₓ′ and/or Ec/Ioₓ′) in the UE 101. However, owing to the fact that the cell reporting parameters are different from conventionally reported corresponding cell parameters, e.g. the CPICH-RSCPₓ and/or the CPICH-Ec/Ioₓ, the cell reallocation decision of the RNC 102 will be different from the conventional cell reallocation decision. In particular, by introducing information based on post-equalization and/or post-demodulation reception qualities (e.g. post-equalization SINR_{x,i} and/or post-demodulation SINR_{x,i} and/or post-equalization MI_{x,i} and/or post-demodulation MI_{x,i}) and/or by taking into account such information from a plurality of carriers (i.e. not only the primary carrier), the quality of cell reallocation and, in particular, of changing the serving cell may be greatly enhanced. This improved cell change or cell reallocation performance of the radio network 100 effectively leads to higher user experience promoted by higher throughput. Note that the throughput is the main KPI (key performance indicator) in cellular mobile radio networks.

In other words, the data throughput of UE 101 can be optimized if the reportings (i.e. the cell reporting parameters) reflect the actual receive conditions in the UE 101 for a specific base station over all N (or a subset Nₛ of all) carriers rather than just the measured CPICH-RSCPₓ and/or CPICH-Ec/Ioₓ and/or PL and/or ISCP of one (e.g. the primary) carrier. In particular in cell boundary scenarios or other conditions of high interference, this will be positively noticed as improved user experience.

FIG. 4 is a schematic block diagram of a reporting signal determining apparatus 410 in UE 101. The UE 101 may comprise one or more antennas 401, one or more RF (radio frequency) units 402, a receiver unit 403 and the reporting signal determining apparatus 410. The reporting signal determining apparatus 410 may comprise a measurement unit 411 and a reporting signal generation unit 412.

The antenna 401, which may also comprise multiple antennas, is coupled to an input of the RF unit 402. The RF unit 402 may comprise a down-conversion unit configured to down-convert the received analog antenna signal to an intermediate frequency (IF) or the baseband. The RF unit 402 may comprise further signal processing such as filtering, analog-to-digital conversion, sampling, and so forth. In particular, as mentioned further above, the RF unit 402 may comprise multiple down-conversion units each configured to down-convert the received antenna signal(s) corresponding to a specific carrier frequency f1, f2, . . . . That way, the RF unit 402 may be configured to provide for a plurality of IF or baseband output signals each associated with one carrier C1, C2, . . . , CN of the multi-carrier network.

The signal (if carrier separation is done downstream) or carrier-specific signals (if carrier separation is done in the RF unit 402) generated by the RF unit 402 is (are) fed into the receiver unit 403. The receiver unit 403 may comprise, e.g., a de-channelization unit (such as, e.g., a descrambling unit and/or a dispreading unit), a combiner, a channel estimator, an equalizer, a channel decoder, a demodulator, and so forth. The receiver unit 403 generates and outputs user data of the UE 101.

The receiver unit 403 may further comprise or may be connected to a measurement unit 411. The measurement unit 411 may be configured to measure a plurality of reception qualities wherein each reception quality indicates a reception quality of a specific carrier i of a specific cell x. As mentioned above, the carrier-specific and cell-specific reception qualities may, e.g., be measured downstream of equalization and/or downstream of demodulation of the user signal. The reception qualities may be expressed, e.g., by SINR-quantities indicative of carrier-specific and cell-specific signal reception qualities (or, e.g., by MI-quantities indicative of carrier-specific and cell-specific signal reception qualities). The cell-specific reception qualities of each carrier (see, e.g., the exemplary quantities SINR_{x,i} indicated in FIG. 2) may be measured for a plurality of cells (e.g. the cells of the active set and the cells of the monitored set).

The reception qualities as measured and output by the measurement unit 411 are provided to the reporting signal generation unit 412. The reporting signal generation unit 412 is configured to generate a reporting signal of a specific cell based on the plurality of reception qualities for the plurality of carriers C1, C2, . . . , CN of the specific cell x. The reporting signal of cell x may contain the cell reporting parameters (e.g. RSCPₓ′ and/or Ec/Ioₓ′) as mentioned above.

In many mobile communication networks the cell reporting parameters are stipulated by the corresponding standard. That is, the standard requires each UE 101 to feedback predetermined cell reporting parameters such as, e.g., CPICH-RSCPₓ and/or CPICH-Ec/Ioₓ (and/or PL and/or ISCP) to the radio network 100. The reporting signal output by the reporting signal generation unit 412 may be configured to provide exactly the cell reporting parameters as required by the standard. However, as will be explained in more detail below, the cell reporting parameters according to the disclosure herein are synthetized, adapted or modified cell reporting parameters of the quantities required by the network 100.

Generally, the reporting signal generation unit 412 may be configured to generate the reporting signal (including the corresponding cell reporting parameters) of a specific cell x based on the reception qualities of a subset or all carriers of the specific cell x. That way, reception quality information of carriers other than the primary carrier is included.

Thus, in general, the cell reporting parameters of the reporting signal, as output by the reporting signal generation unit 412, may be a function of the reception qualities of a subset or all carriers of a specific cell x. According to one possibility, the reception qualities are computed as the SNIR of a specific equalizer. In the following example, the SINR computation of a linear MMSE (Minimum Mean Square Error) equalizer is exemplified.

Assuming a chip-level system model with a serving cell x=1 and an interfering cell x=2, a received symbol y may be written as

y=h₁×x₁+h₂×x₂+n. (1)

In the following,
h₁ denotes a sequence of channel impulse responses h₁ from serving cell x=1 to UE 101;
h₂ denotes a sequence of channel impulse responses h₂ from the interfering cell x=2 to UE 101;
n denotes a sequence of additive white Gaussian noise;
x₁ denotes a transmit sequence of transmit symbols x₁ from serving cell x=1; and
x₂ denotes a transmit sequence of transmit symbols x₂ from interfering cell x=2.
   The linear chip-level equalizer f (e.g. Type3i) can be formulated as follows:

f=(H₁H₁^{H}+H₂H₂^{H}+σ²I)⁻¹eₖ (2)

wherein H₁ is the Toeplitz-matrix of h₁, H₂ is the Toeplitz-matrix of h₂, σ² is the variance, I is the unitary matrix, eₖ is the k^{th} column of the unitary matrix, and superscript H indicates the Hermitian matrix. Taking, as an example, the MMSE equalizer of equation (2), the SINR is given by

$$SINR = \frac{{\vert {fh}_{1} ( 0 ) \vert}^{2}}{{φ}^{2} {\vert f \vert}^{2} I + \sum {fh}_{1} ( j \neq 0 ) {\vert}^{2} + \sum {\vert {fh}_{2} ( j ) \vert}^{2}} \qquad ( 3 )$$

The SINR-values of, e.g., equation (3) can be computed in the UE 101 for all carriers i and all base stations x based on the corresponding channel and noise estimates and the equalizer coefficients. The computation of cell-specific and carrier-specific SINR_{x,i} values of an equalizer such as, e.g., the Type3i equalizer of equation (2) is known in the art and, therefore, needs not to be explained in detail herein.

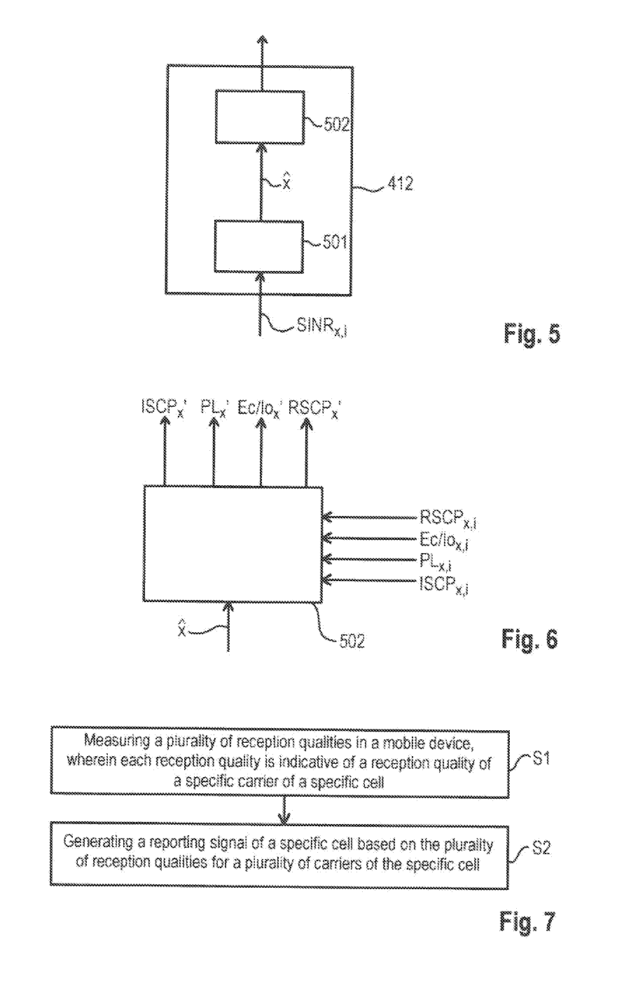

FIG. 5 is a block diagram which schematically illustrates a possible implementation of the reporting signal generation unit 412. Accordingly, the reporting signal generation unit 412 may comprise a preferred cell decision unit 501 and a reporting signal synthesizing unit 512.

The preferred cell decision unit 501 may receive the cell-specific and carrier-specific reception qualities (e.g. SINR_{x,i}) and is configured to decide a preferred cell \hat{x} based on the plurality of received reception qualities. By way of example, the preferred cell \hat{x} may be identified by the following equation

$$\hat{x} = {max}_{x} \{ {\sum }_{i = 1}^{N} log ( 1 + {SINR}_{x , i} ) \} \qquad ( 4 )$$

It is to be noted that typically a NodeB (i.e. a base station BS1, BS2, . . . , BSM) uses the same scrambling code on all carriers C1, C2, . . . , CN in case of multi-carrier operation. This means that the same scrambling code is used on the primary, secondary, tertiary, quaternary, . . . , N^{th} carrier. Thus, the carriers are typically separated already in the frontend (e.g. the RF unit 402) or in one of the initial digital signal processing stages of the receiver unit 403. The NodeBs (e.g. the base station) listed in the active set and/or in the monitored set may be separated by decoding the scrambling code, which is done, e.g., downstream of the carrier separation.

Equation (4) identifies the preferred cell \hat{x} as the cell (or NodeB) out of M potential cells (or NodeBs) listed, e.g., in the active set for which the capacity over all N (or Nₛ) available carriers C1, C2, . . . , CN (or C1, C2, . . . , CNₛ) is maximized.

As mentioned above, the preferred cell \hat{x} is the cell which appears to be the best cell to act as serving cell from the viewpoint of the UE-evaluated reception qualities. The reporting signal synthesizing unit 502 may synthesize the reporting signal (i.e. the cell reporting parameters) based on the determination of the preferred cell \hat{x}.

By way of example, the synthesizing unit 502 may generate the reporting signal of a specific cell based on the decided preferred cell \hat{x}. More specifically, the reporting signal synthesizing unit 502 may be configured to generate the reporting signal such that the reporting signal leads to a cell allocation by the radio network (or, more specifically, the RNC 102) to the preferred cell \hat{x}.

By way of example, it is assumed that a serving cell x=1 and an interfering cell x=2 are measured to provide for the following SINR_{x,i} values:
SINR_{1,p}=γ
SINR_{1,s}=γ−20 dB
SINR_{2,p}=γ−2 dB
SINR_{2,s}=γ.
   In this example p denotes the primary carrier and s denotes the secondary carrier. γ denotes an SINR level in dB. If cell x=1 was the current serving cell, the serving cell would not be changed if only the primary carrier were used as criterion. However, according to the disclosure herein, also the secondary carrier is considered. Therefore, the reporting signal (i.e. the cell reporting parameters thereof) is synthesized so that the serving cell will be changed by the radio network from x=1 to x=2. By way of example, if the cell reporting parameter is the RSCP of the primary carrier of each cell, the generated RSCP₂′ of the second cell x=2 is synthesized to exceed the generated RSCP₁′ of the first cell x=1 in order to manipulate the network cell reallocation decision to switch the serving cell from x=1 to x=2.

FIG. 6 illustrates an exemplary implementation of the reporting signal synthesizing unit 502. The reporting signal synthesizing unit 502 may, e.g., receive measurement values of RSCP_{x,i} and/or Ec/Io_{x,i} and/or PL_{x,i} and/or ISCP_{x,i}. It is also possible that only the values of RSCP_{x,p} and/or Ec/Io_{x,p} and/or PL_{x,p} and/or ISCP_{x,p} are received (i.e. the cell reporting parameters which are conventionally reported to the network). According to the disclosure herein, the values of RSCP_{x,i} and/or the values of Ec/Io_{x,i} and/or the values of PL_{x,i} and/or the values of ISCP_{x,i} (or RSCP_{x,p} and/or Ec/Io_{x,p} and/or PL_{x,p} and/or ISCP_{x,p}) are modified or adapted by the information from the preferred cell decision unit 501, i.e. by the information about the preferred cell \hat{x}. It is also possible that the preferred cell decision unit 501 is bypassed in a way that the reception qualities (e.g. SINR_{x,i}, etc.) are directly input to the reporting signal synthesizing unit 502.

In any case, the reporting signal output by the reporting signal synthesizing unit 502 (and also output by the reporting signal generation unit 412) may comprise the adapted or manipulated cell reporting parameters RSCPₓ′ and/or Ec/Ioₓ′ and/or PLₓ′ and/or ISCPₓ′. That way, the reporting signal generation unit 412 is configured to generate the reporting signal of a specific cell x based on a measurement of an RSCP, in particular the RSCP of a common pilot channel of a primary carrier p of the specific cell x, wherein the measured RSCP_{x,p} is subjected to an adaption based on the plurality of reception qualities (e.g. SINR_{x,i}). Analogously the reporting signal generation unit 412 may be configured to generate the reporting signal of a specific cell x based on a measurement of an Ec/Io, in particular the Ec/Io_{x,p} of a common pilot channel of a primary carrier of the specific cell x, wherein the measured Ec/Io_{x,p} is subjected to an adaption based on the plurality of reception quality (e.g. SINR_{x,i}). Analogously the reporting signal generation unit 412 may be configured to generate the reporting signal of a specific cell x based on a measurement of an PL, in particular the PL_{x,p} of a common pilot channel of a primary carrier of the specific cell x, wherein the measured PL_{x,p} is subjected to an adaption based on the plurality of reception quality (e.g. SINR_{x,i}). Analogously the reporting signal generation unit 412 may be configured to generate the reporting signal of a specific cell x based on a measurement of an ISCP, in particular the ISCP_{x,p} of a common pilot channel of a primary carrier of the specific cell x, wherein the measured ISCP_{x,p} is subjected to an adaption based on the plurality of reception quality (e.g. SINR_{x,i}).

FIG. 7 illustrates a method of determining cell-specific reporting signals in a multi-carrier cellular network 100. The method may be operated by software and/or hardware in a mobile station. It is also possible that some of the processes of the method are implemented in software and executed by a processor controlled by the software, while other processes are implemented in dedicated hardware.

At S1, a plurality of reception qualities in a mobile device are measured, wherein each reception quality indicates a reception quality of a specific carrier of a specific cell. As mentioned above, the reception qualities may, e.g., be expressed by SINR_{x,i}.

At S2, a reporting signal of a specific cell is generated based on the plurality of reception qualities for a plurality of carriers of the specific cell. The reporting signal (including the cell reporting parameters) may be generated by adapting a “conventional” reporting signal based on the measured reception so as to appropriately manipulate the cell (re)allocation decision (e.g. serving cell change decision) of the radio network (e.g. the RNC 102).

### EXAMPLES

The following examples pertain to further embodiments. Example 1 is an apparatus for determining cell-specific reporting signals in a multi-carrier cellular network, the apparatus comprising a measurement unit configured to measure a plurality of reception qualities in a mobile device, wherein each reception quality indicates a reception quality of a specific carrier of a specific cell; and a reporting signal generation unit configured to generate a reporting signal of a specific cell based on the plurality of reception qualities for a plurality of carriers of the specific cell.

In Example 2, the subject matter of Example 1 can optionally include wherein the multi-carrier network is configured to allocate one or more cells to a connection of the mobile device, and wherein the allocation is based on the cell-specific reporting signals.

In Example 3, the subject-matter of any of Examples 1 and 2 can optionally include wherein the reporting signal generation unit is configured to generate the reporting signal of a specific cell based on the reception qualities of all carriers of the specific cell.

In Example 4, the subject-matter of any of the preceding Examples can optionally include wherein each reception quality comprises at least one of a signal-to-interference and noise ratio of a specific carrier of a specific cell or a mutual-information of a specific carrier of a specific cell.

In Example 5, the subject-matter of any of the preceding Examples can optionally include wherein the reporting signal generation unit comprises a preferred cell decision unit configured to decide a preferred cell based on the plurality of reception qualities.

In Example 6, the subject-matter of Example 5 can optionally include wherein the reporting signal generation unit is configured to generate the reporting signal of a specific cell based on the decided preferred cell.

In Example 7, the subject-matter of one of Examples 5 or 6 can optionally include wherein the reporting signal generation unit is configured to generate the reporting signals to allocate to the preferred cell based on the reporting signals

In Example 8, the subject matter of any of the preceding Examples can optionally include wherein the reporting signal generation unit is configured to generate the reporting signal of a specific cell based on a measurement of an RSCP of the specific cell, in particular the RSCP of a common pilot channel of a primary carrier of the specific cell, and wherein the RSCP is subjected to an adaption based on the plurality of reception qualities.

In Example 9, the subject-matter of any of the preceding Examples can optionally include wherein the reporting signal generation unit is configured to generate the reporting signal of a specific cell based on a measurement of an Ec/Io, in particular the Ec/Io of a common pilot channel of a primary carrier of the specific cell, and wherein the Ec/Io is subjected to an adaption based on the plurality of reception qualities.

In Example 10, the subject-matter of any of the preceding Examples can optionally include wherein the mobile device is configured for operation according to a standard selected from the group consisting of HSPA, CDMA, UMTS, TD-SCDMA, IS95, OFDM, or LTE, and their derivatives.

Example 11 is a non-transitory computer readable medium comprising program instructions configured to cause a processor of a mobile device to determine cell-specific reporting signals in a multi-carrier cellular network by controlling the mobile device to measure a plurality of reception qualities, wherein each reception quality indicates a reception quality of a specific carrier of a specific cell, and generating the reporting signal of a specific cell based on the plurality of reception qualities for a plurality of carriers of the specific cell.

In Example 12, the subject-matter of Example 11 can optionally include wherein the program instructions are further configured to cause the processor to decide a preferred cell based on the plurality of reception qualities.

In Example 13, the subject-matter of Examples 12 or 13 can optionally include wherein the program instructions are further configured to cause the processor to generate the reporting signal of a specific cell based on the decided preferred cell.

Example 14 is a method of determining cell-specific reporting signals in a multi-carrier cellular network, the method comprising measuring a plurality of reception qualities in a mobile device, wherein each reception quality indicates a reception quality of a specific carrier of a specific cell; and generating a reporting signal of a specific cell based on the plurality of reception qualities for a plurality of carriers of the specific cell.

In Example 15, the subject-matter of Example 14 can optionally include wherein the multi-carrier cellular network is configured to allocate one or more cells to a connection of the mobile device, and wherein the allocation is based on the cell-specific reporting signals.

In Example 16, the subject-matter of Examples 14 or 15 can optionally include wherein the reporting signal of a specific cell is generated based on the reception qualities of all carriers of the specific cell.

In Example 17, the subject-matter of Examples 14 to 16 can optionally include wherein each reception quality indicates at least one of a signal-to-interference and noise ratio of a specific carrier of a specific cell or of a mutual-information of a specific carrier of a specific cell.

In Example 18, the subject-matter of Examples 14 to 17 can optionally include deciding a preferred cell based on the plurality of reception qualities.

In Example 19, the subject-matter of Examples 14 to 18 can optionally include wherein the reporting signal of a specific cell is generated based on the decided preferred cell.

In Example 20, the subject-matter of Examples 18 or 19 can optionally include wherein the reporting signal of a specific cell is generated to allocate to the preferred cell based on the reporting signals.

In Example 21, the subject-matter of Examples 14 to 20 can optionally include wherein the reporting signal of a specific cell is generated on an event-based scheduling or on a time-based periodic scheduling.

In Example 22, the subject-matter of Examples 14 to 21 can optionally include wherein the reporting signal of a specific cell is generated based on a measurement of an RSCP, in particular the RSCP of a common pilot channel of a primary carrier of the specific cell, wherein the measured RSCP is subjected to an adaption based on the plurality of reception qualities.

In Example 23, the subject-matter of Examples 14 to 22 can optionally include wherein the reporting signal of a specific cell is generated based on a measurement of an Ec/Io, in particular the Ec/Io of a common pilot channel of a primary carrier of the specific cell, wherein the measured Ec/Io is subjected to an adaption based on the plurality of reception qualities.

In Example 24, the subject-matter of Examples 14 to 23 can optionally include wherein the cellular network is a network using hard handover.

In Example 25, the subject-matter of Examples 14 to 24 can optionally include wherein the cellular network is a network using soft handover.

Example 26 is a mobile device including a means for determining cell-specific reporting signals in a multi-carrier cellular network, the means for determining cell-specific reporting signals comprising a measurement unit configured to measure a plurality of reception qualities in the mobile device, wherein each reception quality indicates a reception quality of a specific carrier of a specific cell; and a means for generating reporting signals configured to generate a reporting signal of a specific cell based on the plurality of reception qualities for a plurality of carriers of the specific cell.

In Example 27, the subject-matter of Examples 26 can optionally include wherein the means for generating reporting signals is configured to generate the reporting signal of a specific cell based on the reception qualities of all carriers of the specific cell.

In Example 28, the subject-matter of Examples 26 or 27 can optionally include wherein each reception quality comprises a signal-to-interference and noise ratio of a specific carrier of a specific cell and/or a mutual-information of a specific carrier of a specific cell.

In Example 29, the subject-matter of Example 28 can optionally include wherein the signal-to-interference and noise ratio is a post-equalization or post-demodulation signal-to-interference and noise ratio.

In Example 30, the subject-matter of one of the Examples 26 to 29 can optionally include wherein the means for generating a reporting signal comprises a preferred cell decision unit configured to decide a preferred cell based on the plurality of reception qualities.

In Example 31, the subject-matter of Example 30 can optionally include wherein the means for generating a reporting signal is configured to generate the reporting signal of a specific cell based on the decided preferred cell.

In Example 32, the subject-matter of one of the Examples 26 to 31 can optionally include an RF unit configured to separate the plurality of carriers.

In Example 33, the subject-matter of Example 32 can optionally include a receiver unit configured to equalize signals associated with each carrier of the plurality of carriers.

In Example 34, the subject-matter of one of the Examples 1 to 13 can optionally include wherein the reporting signal generation unit is configured to generate the reporting signal of a specific cell based on a measurement of an PL (pathloss), in particular the PL of a common pilot channel of a primary carrier of the specific cell, wherein the measured PL is subjected to an adaption based on the plurality of reception qualities.

In Example 35, the subject-matter of one of the Examples 1 to 13 can optionally include wherein the reporting signal generation unit is configured to generate the reporting signal of a specific cell based on a measurement of an ISCP (interference on signal code power), in particular the ISCP of a common pilot channel of a primary carrier of the specific cell, wherein the measured ISCP is subjected to an adaption based on the plurality of reception qualities.

In Example 36, the subject-matter of one of the Examples 14 to 24 can optionally include wherein the reporting signal of a specific cell is generated based on a measurement of an PL (pathloss), in particular the PL of a common pilot channel of a primary carrier of the specific cell, wherein the measured PL is subjected to an adaption based on the plurality of reception qualities.

In Example 37, the subject-matter of one of the Examples 14 to 24 can optionally include wherein the reporting signal of a specific cell is generated based on a measurement of an ISCP (interference on signal code power), in particular the ISCP of a common pilot channel of a primary carrier of the specific cell, wherein the measured ISCP is subjected to an adaption based on the plurality of reception qualities.

In addition, while a particular feature or aspect of an embodiment of the invention may have been disclosed with respect to only one of several implementations, such feature or aspect may be combined with one or more other features or aspects of the other implementations as may be desired and advantageous for any given or particular application. It is also to be appreciated that features and/or elements depicted herein are illustrated with particular dimensions relative to one another for purposes of simplicity and ease of understanding, and that actual dimensions may differ substantially from that illustrated herein.

What is claimed is:

1. An apparatus for determining cell-specific reporting signals in a multi-carrier cellular network, the apparatus comprising:
a measurement unit configured to measure a plurality of reception qualities in a mobile device, wherein each reception quality indicates a reception quality of a specific carrier of a specific cell; and
a reporting signal generation unit configured to generate a reporting signal of a specific cell based on the plurality of reception qualities for a plurality of carriers of the specific cell.

2. The apparatus of claim 1, wherein the multi-carrier network is configured to allocate one or more cells to a connection of the mobile device, and wherein the allocation is based on the cell-specific reporting signals.

3. The apparatus of claim 1, wherein the reporting signal generation unit is configured to generate the reporting signal of a specific cell based on the reception qualities of all carriers of the specific cell.

4. The apparatus of claim 1, wherein each reception quality comprises at least one of a signal-to-interference and noise ratio of a specific carrier of a specific cell or a mutual-information of a specific carrier of a specific cell.

5. The apparatus of claim 1, wherein the reporting signal generation unit comprises:
a preferred cell decision unit configured to decide a preferred cell based on the plurality of reception qualities.

6. The apparatus of claim 5, wherein the reporting signal generation unit is configured to generate the reporting signal of a specific cell based on the decided preferred cell.

7. The apparatus of claim 5, wherein the reporting signal generation unit is configured to generate the reporting signals to allocate to the preferred cell based on the reporting signals.

8. The apparatus of claim 1, wherein the reporting signal generation unit is configured to generate the reporting signal of a specific cell based on a measurement of a received signal code power (RSCP) of the specific cell, wherein RSCP comprises RSCP of a common pilot channel of a primary carrier of the specific cell, and wherein the RSCP is subjected to an adaption based on the plurality of reception qualities.

9. The apparatus of claim 1, wherein the reporting signal generation unit is configured to generate the reporting signal of a specific cell based on a measurement of a chip energy (Ec) divided by the interference density (Io), wherein the Ec/Io comprises Ec/Io of a common pilot channel of a primary carrier of the specific cell, and wherein the Ec/Io is subjected to an adaption based on the plurality of reception qualities.

10. The apparatus of claim 1, wherein the mobile device is configured for operation according to a standard selected from the group consisting of HSPA, CDMA, UMTS, TD-SCDMA, IS95, OFDM, or LTE, and their derivatives.

11. A non-transitory computer readable medium comprising program instructions configured to cause a processor of a mobile device to determine cell-specific reporting signals in a multi-carrier cellular network by controlling the mobile device to measure a plurality of reception qualities, wherein each reception quality indicates a reception quality of a specific carrier of a specific cell, and generating the reporting signal of a specific cell based on the plurality of reception qualities for a plurality of carriers of the specific cell.

12. The non-transitory computer readable medium of claim 11, wherein the program instructions are further configured to cause the processor to decide a preferred cell based on the plurality of reception qualities.

13. The non-transitory computer readable medium of claim 12, wherein the program instructions are further configured to cause the processor to generate the reporting signal of a specific cell based on the decided preferred cell.

14. A method of determining cell-specific reporting signals in a multi-carrier cellular network, the method comprising:
measuring a plurality of reception qualities in a mobile device, wherein each reception quality indicates a reception quality of a specific carrier of a specific cell; and
generating a reporting signal of a specific cell based on the plurality of reception qualities for a plurality of carriers of the specific cell.

15. The method of claim 14, wherein the multi-carrier cellular network is configured to allocate one or more cells to a connection of the mobile device, and wherein the allocation is based on the cell-specific reporting signals.

16. The method of claim 15, wherein the reporting signal of a specific cell is generated based on the reception qualities of all carriers of the specific cell.

17. The method of claim 14, wherein each reception quality indicates at least one of a signal-to-interference and noise ratio of a specific carrier of a specific cell or of a mutual-information of a specific carrier of a specific cell.

18. The method of claim 14, further comprising:
deciding a preferred cell based on the plurality of reception qualities.

19. The method of claim 18, wherein the reporting signal of a specific cell is generated based on the decided preferred cell.

20. The method of claims 18, wherein the reporting signal of a specific cell is generated to allocate to the preferred cell based on the reporting signals.

21. The method of claim 14, wherein the reporting signal of a specific cell is generated on an event-based scheduling or on a time-based periodic scheduling.

22. The method of claim 14, wherein the reporting signal of a specific cell is generated based on a measurement of a received signal code power (RSCP) of the specific cell, in particular the RSCP of a common pilot channel of a primary carrier of the specific cell, wherein the measured RSCP is subjected to an adaption based on the plurality of reception qualities.

23. The method of claim 14, wherein the reporting signal of a specific cell is generated based on a measurement of a chip energy (Ec) divided by the interference density (Io), in particular the Ec/Io of a common pilot channel of a primary carrier of the specific cell, wherein the Ec/Io is subjected to an adaption based on the plurality of reception qualities.

24. A mobile device comprising:
a means for determining cell-specific reporting signals in a multi-carrier cellular network, the means for determining cell-specific reporting signals comprising a measurement unit configured to measure a plurality of reception qualities in the mobile device, wherein each reception quality indicates a reception quality of a specific carrier of a specific cell; and
a means for generating reporting signals configured to generate a reporting signal of a specific cell based on the plurality of reception qualities for a plurality of carriers of the specific cell.

25. The mobile device of claim 24, wherein the means for generating reporting signals is configured to generate the reporting signal of a specific cell based on the reception qualities of all carriers of the specific cell.
